(19) United States
(12) Patent Application Publication
(10) Pub. No.: US 2025/0310155 A1
(43) Pub. Date: Oct. 2, 2025

(54) Sparse LMS Method Combining Zero Attraction Penalty and Attraction Compensation

(71) Applicant: CHONGQING UNIVERSITY OF POSTS AND TELECOMMUNlCATlONS, Chongqing (CN)

(72) Inventors: Hongsheng Zhang, Chongqing (CA); Jin MENG, Chongqing (CN); Jizhang GAN, Chongqing (CN); Hong YANG, Chongqing (CN); Yi HUANG, Chongqing (CN); Ting LIU, Chongqing (CN)

(21) Appl. No.: 18/037,772

(22) PCT Filed: Mar. 15, 2022
(86) PCT No.: PCT/CN2022/080833

§ 371 Date: May 15, 2025

(30) Foreign Application Priority Data
Mar. 1, 2021 (CN) 202110227578.0

(51) Int. Cl. H04L 25/02; H04L 25/03

(52) U.S. Cl. CPC H04L 25/025; H04L 25/03

(57) ABSTRACT

The invention relates to a sparse LMS method combining zero attraction penalty and attraction compensation which belongs to the field of signal processing. The method combines zero attraction penalty and attraction compensation to divide coefficients of an estimation filter into a near-zero coefficient, a small coefficient and a large coefficient, and then different attraction methods are adopted; at each iterative update, the near-zero coefficient of the estimation filter is calculated by only the product term in the iterative update formula; for the large coefficient of the estimation filter, a small amount of attraction compensation is performed to speed up the convergence speed of the estimation filter coefficients to approximate the large coefficients of the channel; for the small coefficient of the estimation filter, if the coefficient approximates the zero coefficient value of the channel or the large coefficient value of the channel in the iterative process, the aforementioned methods for the near zero coefficient of the estimation filter and the large coefficient of the estimation filter are adopted, otherwise, a simple zero attraction penalty is adopted to the coefficient. The method has fast convergence speed, low complexity and wide range of tuning parameters.

### TECHNICAL FIELD

The invention belongs to the field of signal processing and relates to a sparse LMS method combining zero attraction penalty and attraction compensation.

### BACKGROUND

Many channels are sparse, and specific adaptive filtering algorithms are required to identify such sparse channels. The current algorithm types for sparse system identification are l₀-norm, l₁-norm and lₚ-norm, where l₀-norm is the zero attraction penalty for the coefficients of the estimation filter within a certain small threshold, and l₁-norm is a zero attraction penalty for all coefficients of the estimation filter, and lₚ-norm is a zero attraction penalty for all coefficients of the estimation filter including division and exponent. lₚ-norm algorithm achieves better performance than l₀-norm algorithm and l₁-norm algorithm, but this method is difficult to implement in hardware due to its high complexity. The typical algorithm in the l₁-norm algorithm is zero attraction ZA-LMS (Zero-attracting Least Mean Square), which gives the same zero attraction penalty to all channel coefficients and does not distinguish between zero and non-zero channel coefficients. As a result, its MSD (Mean Square deviation) is not excellent. Y. Chen also proposed a reweighted ZA-LMS (Reweight Zero-attracting Least Mean Square). The zero attraction function of this method subtly reduces and enlarges the large and small coefficients respectively, so that it is more reasonable to estimate the channel, but this method requires division operation. Y. Gu proposed a l₀-LMS method which performs zero attraction penalty only when the coefficients of the estimation filter are lower than a certain threshold, but this method has great restrictions on the optimal parameter selection and the accuracy of the estimation coefficients. In order to obtain a lower mean square steady-state difference and reduce parameter constraints, LeiLuo proposed an l₀-ILMS method with lower parameter constraints and lower MSD, which did not deal with the larger coefficients of the estimation filter as well.

### INVENTION CONTENT

In view of this, the purpose of the present invention is to provide a sparse LMS method combining zero attraction penalty and attraction compensation. The method combines zero attraction penalty and attraction compensation to divide coefficients of an estimation filter into a near-zero coefficient, a small coefficient and a large coefficient, and then different attraction methods are adopted; at each iterative update, the near-zero coefficient of the estimation filter is calculated by only the product term in the iterative update formula; for the large coefficient of the estimation filter, a small amount of attraction compensation is performed to speed up the convergence speed of the estimation filter coefficients to approximate the large coefficients of the channel; for the small coefficient of the estimation filter, if the coefficient approximates the zero coefficient value of the channel or the large coefficient value of the channel in the iterative process, the aforementioned methods for the near zero coefficient of the estimation filter and the large coefficient of the estimation filter are adopted, otherwise, a simple zero attraction penalty is adopted to the coefficient.

To achieve the above purpose, the present invention provides the following technical solution:

A sparse LMS method combining zero attraction penalty and attraction compensation, a sparse system identification model is established:

As shown in FIG. 1, input signal X(n)=[x(n) x(n−1) . . . x(n−L+1)]^{T} is a zero-mean Gaussian signal with power σₓ², n is sequence number of the signal, and L is filter length; W(n)=[w₀ w₁ . . . w_{L-1}]^{T} is coefficient of estimation filter, H(n)=[h₀ h₁ . . . h_{L-1}] is coefficient of sparse channel, and most of coefficients in H(n) are equal to zero or close to; time-varying is considered, the vector H(n) is expressed as:

$$H ( n + 1 ) = H ( n ) + q ( n ) \qquad ( 1 )$$

wherein q(n) is covariance zero mean Gaussian white noise with power σ_{q}², its autocorrelation matrix is E[q(n)q^{T}(n)]=σ_{q}²I, and I is unit matrix; n(n) is zero mean Gaussian white noise with power σ₀²; q(n), X(n) and n(n) are all assumed to be independent of each other;
y(n) and d(n) are respectively:

$$y ( n ) = {W}^{T} ( n ) X ( n ) \qquad ( 2 )$$

$$d ( n ) = {H}^{T} ( n ) X ( n ) + n ( n ) \qquad ( 3 )$$

its error output signal is:

$$\begin{matrix}e ( n ) = {H}^{T} ( n ) X ( n ) + n ( n ) - {W}^{T} ( n ) X ( n ) \\ = d ( n ) - y ( n )\end{matrix} \qquad ( 4 )$$

iterative update equation of the lc-LMS method is:

$$W ( n + 1 ) = W ( n ) + μ e ( n ) X ( n ) + {f}_{C 1} ( n ( n ) ) \\ wherein \qquad ( 5 )$$

$${f}_{C 1} ( W ( n ) ) = \{ \begin{matrix}- {W}_{i} ( n ) , & \vert {W}_{i} ( n ) \vert < \frac{1}{β} \\ - ρ ϕ {W}_{i} ( n ) , & \frac{1}{β} \leq \vert {W}_{i} ( n ) \vert < \frac{1}{ϕ} \\ \frac{ρ}{ϕ} {W}_{i} ( n ) , & \frac{1}{ϕ} \leq \vert {W}_{i} ( n ) \vert\end{matrix} \qquad ( 6 )$$

according to equations (5) and (6), its estimation filter iteration equation is changed to:

$$W ( n + 1 ) = μ e ( n ) X ( n ) + {f}_{C 2} ( W ( n ) ) \\ wherein \qquad ( 7 )$$

$${f}_{C 2} ( W ( n ) ) = \{ \begin{matrix}0 , & \vert {W}_{i} ( n ) \vert < \frac{1}{β} \\ ( 1 - ρ ϕ ) {W}_{i} ( n ) , & \frac{1}{β} \leq \vert {W}_{i} ( n ) \vert < \frac{1}{ϕ} \\ ( 1 + \frac{ρ}{ϕ} ) {W}_{i} ( n ) , & \frac{1}{ϕ} \leq \vert {W}_{i} ( n ) \vert\end{matrix} \qquad ( 8 )$$

wherein ρ is strength of attraction; β is boundary parameter that distinguishes between near-zero coefficient and small coefficient; ϕ is boundary parameter that distinguishes small coefficient and large coefficient, and effectively enlarges the small coefficient and reduces the large coefficient; within the range

$$\vert {W}_{i} ( n ) \vert < \frac{1}{β} ,$$

the function −Wᵢ(n) is substituted into function (5) to cancel out Wᵢ(n) in each iterative update formula, so that the iterative update formula containing product term μe(n)X(n) achieves a large zero-attraction penalty as the next coefficient of estimation filter; within the range

$$\frac{1}{β} \leq \vert {W}_{i} ( n ) \vert < \frac{1}{ϕ} ,$$

the function −ϕWᵢ(n) performs amplified zero attraction penalty for small coefficient, which is called floating coefficient; within the range

$$\frac{1}{ϕ} \leq \vert {W}_{i} ( n ) \vert ,$$

a new attraction method is adopted that a small amount of compensation is added when the coefficient value of the type is updated in each iteration, so that the coefficient of the estimation filter approaches the large coefficient value of the channel faster.

Further, in the method, an estimation filter W(n) is set to make the coefficients of the estimation filter perform iterative update of equation (7) and subtract from the echo signal d(n) to obtain the final error signal e(n) to achieve echo cancellation.

Further, the method is applied to the echo self-excitation problem existing in the same-frequency repeater, the acoustic echo phenomenon in the microphone and the noise cancelling earphone; in the repeater of wireless communication, the same-frequency repeater is arranged to expand the signal coverage by using adaptive filtering algorithm to solve the problem of self-excitation caused by echo; the main transmitting platform emits useful signals and transmits them to the same-frequency repeater, and the same-frequency repeater amplifies the useful signals through the power amplifier and then transmits the useful signals to the receiving terminal;
the input signal X(n) of lc-LMS is the signal transmitted by the transmitting platform, and H(n) represents the wireless sparse channel; the same-frequency repeater contains an estimation filter, and the same-frequency repeater will use the estimation filter to generate the received signal of the transmitting platform into y(n) signal; the same-frequency repeater synthesizes the received signal of the transmitting platform through the wireless sparse channel and the Gaussian white noise n(n) of the channel to generate a d(n) signal; inside the same-frequency repeater, e(n)=d(n)−y(n) is calculated to cancel the echo signal.

The beneficial effect of the present invention is to propose a new type of l_{c}-LMS method, which combines zero attraction penalty and attraction compensation to divide coefficients of an estimation filter into a near-zero coefficient, a small coefficient and a large coefficient, and then different attraction methods are adopted; at each iterative update, the near-zero coefficient of the estimation filter is calculated by only the product term in the iterative update formula; for the large coefficient of the estimation filter, a small amount of attraction compensation is performed to speed up the convergence speed of the estimation filter coefficients to approximate the large coefficients of the channel; for the small coefficient of the estimation filter, if the coefficient approximates the zero coefficient value of the channel or the large coefficient value of the channel in the iterative process, the aforementioned methods for the near zero coefficient of the estimation filter and the large coefficient of the estimation filter are adopted, otherwise, a simple zero attraction penalty is adopted to the coefficient.

Other advantages, objectives and features of the present invention will be illustrated in the following description to some extent, and will be apparent to those skilled in the art based on the following investigation and research to some extent, or can be taught from the practice of the present invention. The objectives and other advantages of the present invention can be realized and obtained through the following description.

### DESCRIPTION OF DRAWINGS

To enable the purpose, the technical solution and the advantages of the present invention to be more clear, the present invention will be preferably described in detail below in combination with the drawings, wherein:

FIG. 1 is the sparse system identification model;

FIG. 2 is the structure diagram of l_{c}-LMS method;

FIG. 3 is the same frequency repeater;

FIG. 4 is the coefficient of the communication channel H;

FIG. 5 is the MSD simulation diagram of ZA-LMS, RZA-LMS, l₀-LMS, l₀-ILMS, l_{c}-LMS and l_{c}-LMS-MSDmin at different attraction weights p;

FIG. 6 is the MSD simulation diagram of l₀-LMS, l₀-ILMS, l_{c}-LMS and l_{c}-LMS-MSDmin at different β;

FIG. 7 is the MSD simulation diagram of l_{c}-LMS and l_{c}-LMS-MSDmin at different ϕ;

FIG. 8 shows that the l_{c}-LMS method achieves the same MSD value as l₀-ILMS with lower complexity and faster convergence speed;

FIG. 9 is a MSD curve diagram of coefficients in a sparse channel corresponding to Hᵢ(i=1,2,3).

### DETAILED DESCRIPTION

Embodiments of the present invention are described below through specific embodiments. Those skilled in the art can understand other advantages and effects of the present invention easily through the disclosure of the description. The present invention can also be implemented or applied through additional different specific embodiments. All details in the description can be modified or changed based on different perspectives and applications without departing from the spirit of the present invention. It should be noted that the figures provided in the following embodiments only exemplarily explain the basic conception of the present invention, and if there is no conflict, the following embodiments and the features in the embodiments can be mutually combined.

Wherein the drawings are only used for exemplary description, are only schematic diagrams rather than physical diagrams, and shall not be understood as a limitation to the present invention. In order to better illustrate the embodiments of the present invention, some components in the drawings may be omitted, scaled up or scaled down, and do not reflect actual product sizes. It should be understandable for those skilled in the art that some well-known structures and description thereof in the drawings may be omitted.

Same or similar reference numerals in the drawings of the embodiments of the present invention refer to same or similar components. It should be understood in the description of the present invention that terms such as “upper”, “lower”, “left”, “right”, “front” and “back” indicate direction or position relationships shown based on the drawings, and are only intended to facilitate the description of the present invention and the simplification of the description rather than to indicate or imply that the indicated device or element must have a specific direction or constructed and operated in a specific direction, and therefore, the terms describing position relationships in the drawings are only used for exemplary description and shall not be understood as a limitation to the present invention; for those ordinary skilled in the art, the meanings of the above terms may be understood according to specific conditions.

The present invention will be further described in detail below in conjunction with the accompanying drawings:

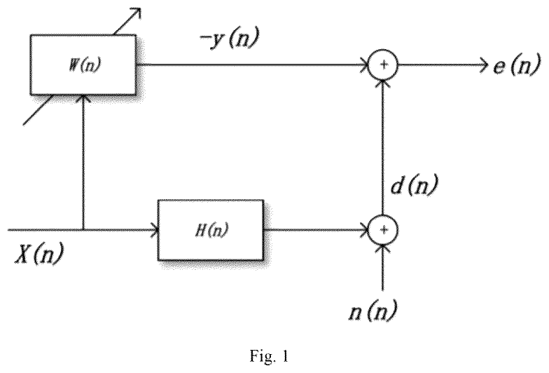

The main research of the present invention is based on the background of sparse system identification, and the sparse system identification model is given in FIG. 1.

As shown in FIG. 1, input signal X(n)=[x(n) x(n−1) . . . x(n−L+1)]^{T} is a zero-mean Gaussian signal with power σₓ², n is sequence number of the signal, and L is filter length; W(n)=[w₀ w₁ . . . w_{L-1}]^{T} is coefficient of estimation filter, H(n)=[h₀ h₁ . . . h_{L-1}] is coefficient of sparse channel, and most of coefficients in H(n) are equal to zero or close to; time-varying is considered, the vector H(n) is expressed as:

$$H ( n + 1 ) = H ( n ) + q ( n ) \qquad ( 1 )$$

wherein q(n) is covariance zero mean Gaussian white noise with power σ_{q}², its autocorrelation matrix is E[q(n)q^{T}(n)]=σ_{q}²I, and I is unit matrix; n(n) is zero mean Gaussian white noise with power σ₀²; q(n), X(n) and n(n) are all assumed to be independent of each other;

As shown in FIG. 1, y(n) and d(n) are respectively:

$$y ( n ) = {W}^{T} ( n ) X ( n ) \qquad ( 2 )$$

$$d ( n ) = {H}^{T} ( n ) X ( n ) + n ( n ) \qquad ( 3 )$$

its error output signal is:

$$\begin{matrix}e ( n ) = {H}^{T} ( n ) X ( n ) + n ( n ) - {W}^{T} ( n ) X ( n ) \\ = d ( n ) - y ( n )\end{matrix} \qquad ( 4 )$$

iterative update formula for ZA-LMS method is:

$$W ( n + 1 ) = W ( n ) + μ e ( n ) X ( n ) - {ρ}_{ZA} sgn [ W ( n ) ] \qquad ( 5 )$$

wherein μ is the step factor, ρ_{ZA} is the attraction weight,

$$sgn [ W ( n ) ] = \{ \begin{matrix}\frac{x}{\vert x \vert} , & x \neq 0 \\ 0 , & x = 0\end{matrix} \qquad ( 6 )$$

iterative update formula for RZA-LMS method is:

$$W ( n + 1 ) = W ( n ) + μ e ( n ) X ( n ) - {ρ}_{RZA} \frac{sgn \text{?} W ( n ) \text{?}}{sgn \text{?} W ( n ) \text{?}} \qquad ( 7 )$$

$$\text{?} \text{indicates text missing or illegible when filed}$$

wherein ρ_{RZA} is the attraction weight.
iterative update formula for l₀-LMS method is:

$$W ( n + 1 ) = W ( n ) + μ e ( n ) X ( n ) + ρ {f}_{1} ( W ( n ) ) \qquad ( 8 )$$

wherein ρ is the attraction weight,

$${f}_{1} ( W ( n ) ) = \{ \begin{matrix}{β}^{2} {W}_{i} ( n ) - β sgn [ {W}_{i} ( n ) ] , 0 < \vert {W}_{i} ( n ) \vert < \frac{1}{β} \\ 0 , otherwise\end{matrix} \qquad ( 9 )$$

where β is the positive control parameter.
iterative update formula for l₀-ILMS method is:

$$W ( n + 1 ) = W ( n ) + μ e ( n ) X ( n ) + ρ {f}_{2} ( W ( n ) ) \qquad ( 10 )$$

$$wherein$$

$${f}_{2} ( W ( n ) ) = \{ \begin{matrix}- ε {W}_{i} ( n ) , \vert {W}_{i} ( n ) \vert \leq \frac{β}{{β}^{2} + ε} \\ {β}^{2} {W}_{i} ( n ) - β sgn ( {W}_{i} ( n ) ) , \frac{β}{{β}^{2} + ε} < \vert {W}_{i} ( n ) \vert < \frac{1}{β} \\ 0 , otherwise\end{matrix} \qquad ( 11 )$$

$$ε = ( 1 - μ {σ}_{x}^{2} ) / ρ \qquad ( 12 )$$

Compared with the l_{c}-LMS method, the l₀-ILMS method only adds one more term −εWᵢ(n) to the zero attraction function, so that l₀-ILMS method increases the accuracy of estimating sparseness for sparse system identification.
iterative update equation of the l_{c}-LMS method is:

$$W ( n + 1 ) = W ( n ) + μ e ( n ) X ( n ) + {f}_{C 1} ( n ( n ) ) \qquad ( 13 )$$

$$wherein$$

$${f}_{C 1} ( W ( n ) ) = \{ \begin{matrix}- {W}_{i} ( n ) , \vert {W}_{i} ( n ) \vert < \frac{1}{β} \\ - ρ ϕ {W}_{i} ( n ) , \frac{1}{β} \leq \vert {W}_{i} ( n ) \vert < \frac{1}{ϕ} \\ \frac{ρ}{ϕ} {W}_{i} ( n ) , \frac{1}{ϕ} \leq \vert {W}_{i} ( n ) \vert\end{matrix} \qquad ( 14 )$$

according to equations (13) and (14), its estimation filter iteration equation is changed to:

$$W ( n + 1 ) = μ e ( n ) X ( n ) + {f}_{C 2} ( W ( n ) ) \qquad ( 15 )$$

$$wherein$$

$${f}_{C 1} ( W ( n ) ) = \{ \begin{matrix}0 , \vert {W}_{i} ( n ) \vert < \frac{1}{β} \\ ( 1 - ρ ϕ ) {W}_{i} ( n ) , \frac{1}{β} \leq \vert {W}_{i} ( n ) \vert < \frac{1}{ϕ} \\ ( 1 + \frac{ρ}{ϕ} ) {W}_{i} ( n ) , \frac{1}{ϕ} \leq \vert {W}_{i} ( n ) \vert\end{matrix} \qquad ( 16 )$$

wherein ρ is strength of attraction; β is boundary parameter that distinguishes between near-zero coefficient and small coefficient; ϕ is boundary parameter that distinguishes small coefficient and large coefficient, and effectively enlarges the small coefficient and reduces the large coefficient;
Assume that there are P non-zero coefficients (large coefficient values) in the channel, that is, there are P coefficients in the function ƒ_{C2}(Wᵢ(n)) obeying

$$\frac{1}{ϕ} \leq \vert {W}_{i} ( n ) \vert ,$$

assuming M coefficients obeying

$$\vert {W}_{í} ( n ) \vert < \frac{1}{β} ,$$

and L-P-M coefficients obeying

$$\frac{1}{β} \leq \vert {W}_{í} ( n ) \vert < \frac{1}{ϕ} .$$

Assume that there are N coefficients in the function ƒ_{C2}(Wᵢ(n)) obeying

$$\vert {W}_{í} ( n ) \vert \leq \frac{β}{{β}^{2} + ω \text{?}} \text{?}$$

$$\text{?} \text{indicates text missing or illegible when filed}$$

and L-P-N coefficients obeying

$$\frac{β}{{β}^{2} + ω \text{?}} < \vert {W}_{í} ( n ) \vert < \frac{1}{β} .$$

$$\text{?} \text{indicates text missing or illegible when filed}$$

Table 1 shows the complexity comparison of iterative update equations for various algorithms.

TABLE 1
The complexity comparison for various algorithms

| Algorithm | Addition | Multiplication | Division |
|---|---|---|---|
| ZA-LMS | 2L | L + 1 | — |
| RZA-LMS | 3L | 2L + 1 | L |
| l₀-LMS | 3L-P | 3L-2P + 1 | — |
| l₀-ILMS | 3L-2P-N | 3L-2P-N + 1 | — |
| l_{c}-LMS | L-M | 2L-M + 1 | — |

Taking

$$P = \frac{1}{3} L , \text{} N \approx M \approx \frac{3}{4} L$$

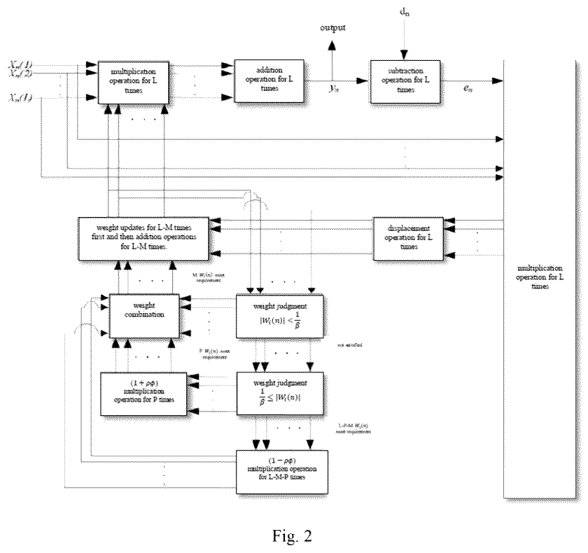

as an example, the addition and multiplication operations of the l_{c}-LMS method are 87.5% and 37.35% lower than the current best-performing—l₀-ILMS method, respectively. The structure diagram of l_{c}-LMS method is shown in FIG. 2.

Nowadays, echo cancellation is an important application of adaptive filtering. There is a coupled echo in the same-frequency repeater, and there is also a coupled echo between the microphone and the speaker. Aiming at this echo problem, an l_{c}-LMS method with lower complexity, faster convergence and wider tuning parameters is proposed. In FIG. 1, X(n) is the useful signal, H(n) is the sparse channel of the echo path in the wireless communication system, and d(n) is the received echo signal which is not required signal. Echo cancellation is to cancel this echo signal. That is, an estimation filter W(n) is set, so that the estimation filter coefficients are iteratively updated by equation (15) and subtracted from the echo signal d(n) to obtain the final error signal e(n). This process is echo cancellation.

One practical application of the present invention is in repeaters for wireless communications.

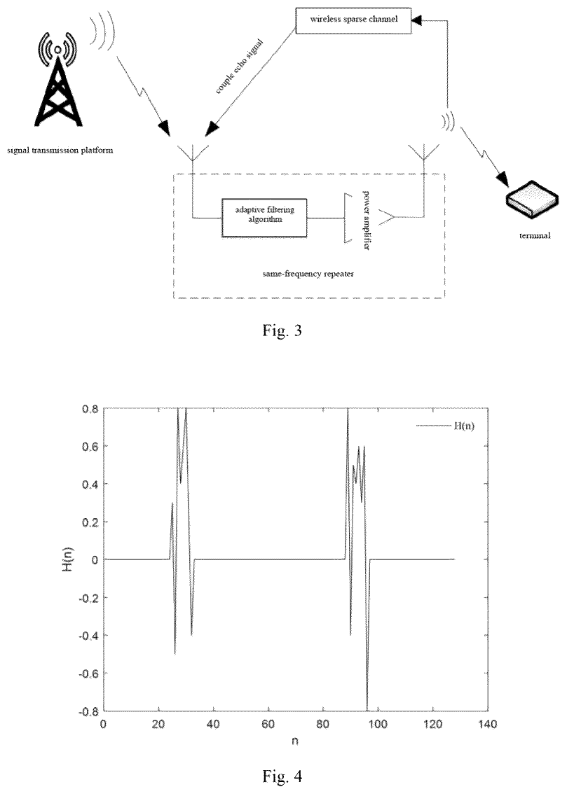

In a wireless communication system, there will be weak signals or signal loss in places that are too far away from the main transmitting antenna and where the building density is high. In order to solve this problem, it is necessary to arrange a repeater with the same frequency to expand the signal coverage, but there is a problem that the echo causes the repeater self-excitation. In order to solve the problem of the repeater, an adaptive filtering algorithm can be used. The same frequency repeater is shown in FIG. 3.

As shown in FIG. 3, the main transmitting platform emits useful signals and transmits them to the same-frequency repeater, and the same-frequency repeater amplifies the useful signals through the power amplifier, and then transmits the useful signals to the receiving terminal. However, when the same-frequency repeater transmits signals, a part of the signal is transmitted back to the receiving end of the same-frequency repeater through the wireless sparse channel, and this part of the signal will cause the same-frequency repeater to generate self-excitation. Studies have shown that most wireless communication channels are sparse, especially digital multimedia communication channels. Therefore, an l_{c}-LMS method with low complexity and excellent performance for sparse channel and echo cancellation is proposed to cancel the signal transmitted to the same-frequency repeater through the wireless sparse channel.

The input signal X(n) of the l_{c}-LMS is the signal transmitted by the transmitting platform, and H(n) represents the wireless sparse channel. The same-frequency repeater contains an estimation filter, and the same-frequency repeater generates the y(n) signal by passing the received signal of the transmitting platform through the estimation filter; the same-frequency repeater passes the received signal of the transmitting platform through the wireless sparse channel and the Gaussian white noise n(n) of the channel are synthesized to produce a d(n) signal. Inside the same-frequency repeater, e(n)=d(n)−y(n) will be calculated to cancel the echo signal.

### Sparse Channel Simulation Experiment

In the simulation, equation (15) and equation (16) are chosen by iteration update equation of the estimation filter. MSD is used as the criterion for channel estimation which is MSD(n)=Tr(E{(W(n)−H(n)) (W(n)−H(n))^{T}}), where H(n) represents the unknown sparse channel, and W(n) represents the estimated filter coefficients. For all the experiments below, 1000 Monte Carlo iterations were used to obtain each point. Select the input signal power as 1 and the noise power as 10⁻². Channel coefficient sets

$$H = [ \begin{matrix}{0}_{24 \times 1} ; 0.3 ; − 0.5 ; 0.8 ; 0.4 ; 0.6 , 0.8 , 0.2 ; − 0.4 ; {0}_{56 \times 1} ; \\ 0.8 ; − 0.4 ; 0.5 ; 0.4 ; 0.6 ; 0.3 ; 0.6 ; − 0.8 ; {0}_{32 \times 1}\end{matrix} ]$$

and the coefficient simulation of its channel is shown in FIG. 4.

In order to verify the validity of the algorithm of the present invention, the parameter selection of all the above-mentioned algorithms is simulated in the above-mentioned system environment. Table 2 sets an example of the three parameters.

TABLE 2
Parameter change settings

| Algorithm | ρ | β | ϕ |
|---|---|---|---|
| ZA-LMS | change | — | — |
| RZA-LMS | change | — | — |
| l₀-LMS | change | 100 | — |
| | 3 × 10⁻⁵ | change | — |
| l₀-ILMS | change | 100 | — |
| | 2 × 10⁻⁴ | change | — |
| l_{c}-LMS | change | 100 | 30 |
| | 2 × 10⁻⁴ | change | 30 |
| | 2 × 10⁻⁴ | 100 | change |

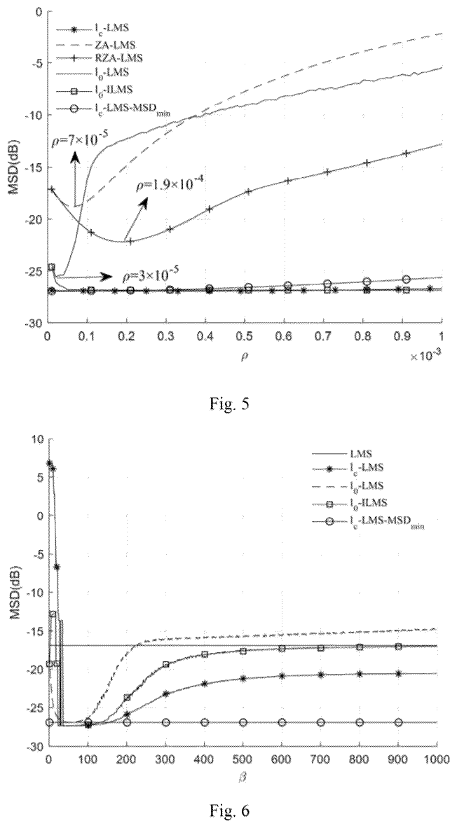

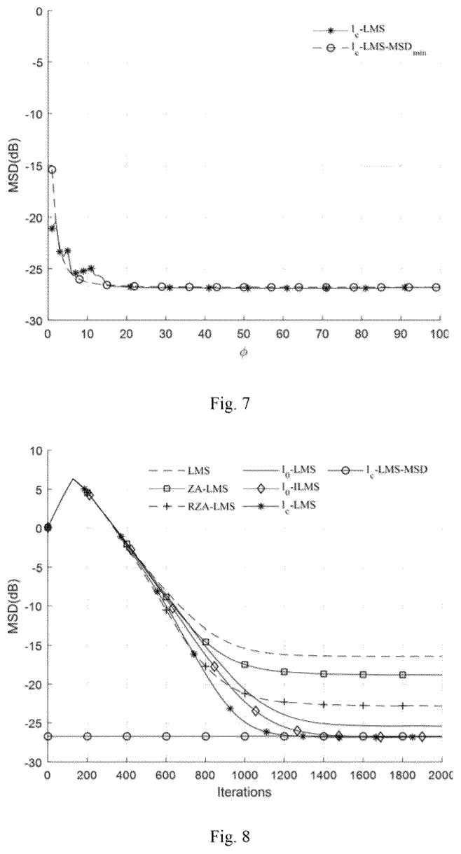

FIG. 5, FIG. 6 and FIG. 7 show the simulation diagrams of the changes of the three parameters.

As shown in FIG. 5, the l₀-ILMS and l_{c}-LMS methods are not sensitive to the tuning parameters, and ρ values are marked in the figure that the MSD values of ZA-LMS, RZA-LMS, and l₀-LMS methods reach the lowest value. As shown in FIG. 6, when the harmonic parameter β is large, the MSD value of the l_{c}-LMS method is better than the LMS and the l₀-ILMS method. The effective range of the tuning parameter of the l_{c}-LMS method is far greater than the effective range of the tuning parameter of the l₀-ILMS method. However, when P is small, the l_{c}-LMS method is not stable. As shown in FIG. 5, FIG. 6 and FIG. 7, the minimum MSD value of the theory of the l_{c}-LMS method is basically consistent with the minimum MSD value of the simulation.

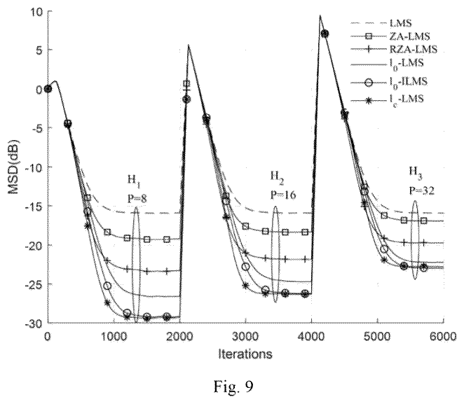

As a result, when the simulation parameter β is 100, the ρ values of ZA-LMS, RZA-LMS, l₀-LMS, l₀-ILMS, and l_{c}-LMS are 7×10⁻⁵, 1.9×10⁻⁴, 3×10⁻⁵, 2×10⁻⁴ and 2×10⁻⁴, respectively. As shown in FIG. 8 and FIG. 9, each data point is obtained by Monte Carlo simulation for 1,000 times.

As shown in FIG. 8, the l_{c}-LMS method achieves the same MSD value as l₀-ILMS with lower complexity and faster convergence.

In order to test the stability of the algorithm, all of the above algorithms are simulated on various sparse channels. The non-zero coefficients of the sparse channel are set P=8, 16, 32 whose coefficients of the channel are

$${H}_{1} = [ {0}_{16 \times 1} ; 0.2 ; 0.5 ; − 0.3 ; 0.5 ; {0}_{56 \times 1} ; 0.5 ; − 0.3 ; 0.6 ; − 0.4 ; {0}_{48 \times 1} ] ,$$

$${H}_{2} = [ \begin{matrix}{0}_{24 \times 1} ; 0.6 ; − 0.5 ; 0.2 ; − 0.3 ; 0.8 , − 0.4 , 0.9 ; − 0.4 ; {0}_{56 \times 1} ; \\ 0.2 ; − 0.2 ; 0.8 ; 0.4 ; − 0.4 ; − 0.8 ; 0.3 ; − 0.2 ; {0}_{32 \times 1}\end{matrix} ] ,$$

$${H}_{3} = [ \begin{matrix}{0}_{56 \times 1} ; 0.8 ; − 0.5 ; 0.7 ; − 0.3 ; − 0.6 , 0.8 , − 0.5 ; 0.2 ; ; 0.8 ; − 0.6 ; 0.5 ; − 0.3 ; − 0.2 ; \\ {0}_{16 \times 1} ; 0.1 ; − 0.5 ; − 0.6 ; 0.8 ; − 0.2 ; − 0.4 ; − 0.2 ; − 0.8 ; 0.1 ; − 0.8 ; − 0.2 ; 0.7 ; \\ − 0.6 ; 0.8 ; 0.6 ; − 0.8 ; {0}_{24 \times 1}\end{matrix} ]$$

Simulation parameters β=100, μ=0.00, the ρ values of ZA-LMS, RZA-LMS, l₀-LMS, l₀-ILMS and l_{c}-LMS are 7×10⁻¹, 1.9×10⁻⁴, 3×10⁻⁵, 2×10⁻⁴ and 2×10⁻⁴, respectively. The simulation of the above algorithm is shown in FIG. 9.

In FIG. 9, in various sparse channel simulations, the l_{c}-LMS method has faster convergence speed, lower complexity and a wider range of tuning parameter β compared with l₀-ILMS. The method can be applied in sparse system identification and echo cancellation applications.

The above descriptions are only examples of the invention, and are not used to limit the protection scope of the invention. For those skilled in the art, the application can have various modifications and changes. Any modification, equivalent replacement, improvement, etc. made within the spirit and principle of this invention shall be included in the protection scope of this invention.

1. A sparse LMS method combining zero attraction penalty and attraction compensation, characterized by:
a sparse system identification model is established, input signal X(n)=[x(n) x(n−1) . . . x(n−L+1)]^{T} is a zero-mean Gaussian signal with power σₓ², n is sequence number of the signal, and L is filter length; W(n)=[w₀ w₁ . . . w_{L-1}] is coefficient of estimation filter, H(n)=[h₀ h₁ . . . h_{L-1}] is coefficient of sparse channel, and most of coefficients in H(n) are equal to zero or close to; time-varying is considered, the vector H(n) is expressed as:
$$H ( n + 1 ) = H ( n ) + q ( n ) \qquad ( 1 )$$
wherein q(n) is covariance zero mean Gaussian white noise with power σ_{q}², its autocorrelation matrix is E[q(n)q^{T}(n)]=σ_{w}²I, and I is unit matrix; n(n) is zero mean Gaussian white noise with power σ₀²; q(n), X(n) and n(n) are all assumed to be independent of each other;
y(n) and d(n) are respectively:
$$y ( n ) = {W}^{T} ( n ) X ( n ) \qquad ( 2 )$$
$$d ( n ) = {H}^{T} ( n ) X ( n ) + n ( n ) \qquad ( 3 )$$
its error output signal is:
$$\begin{matrix}e ( n ) = {H}^{T} ( n ) X ( n ) + n ( n ) - {W}^{T} ( n ) X ( n ) \\ = d ( n ) - y ( n )\end{matrix} \qquad ( 4 )$$
iterative update equation of the l_{c}-LMS method is:
$$W ( n + 1 ) = W ( n ) + μ e ( n ) X ( n ) + {f}_{C 1} ( n ( n ) ) \qquad ( 5 )$$
$$wherein$$
$${f}_{C 1} ( W ( n ) ) = \{ \begin{matrix}− {W}_{i} ( n ) & , \text{} \vert {W}_{i} ( n ) \vert < \frac{1}{β} \\ − ρϕ {W}_{i} ( n ) & , \text{} \frac{1}{β} \leq \vert {W}_{i} ( n ) \vert < \frac{1}{ϕ} \\ \frac{ρ}{ϕ} {W}_{i} ( n ) & , \text{} \frac{1}{ϕ} \leq \vert {W}_{i} ( n ) \vert\end{matrix} \qquad ( 6 )$$
according to equations (5) and (6), its estimation filter iteration equation is changed to:
$$W ( n + 1 ) + μ e ( n ) X ( n ) + {f}_{C 2} ( W ( n ) ) \qquad ( 7 )$$
$$wherein$$
$${f}_{C 2} ( W ( n ) ) = \{ \begin{matrix}0 & , \text{} \vert {W}_{i} ( n ) \vert < \frac{1}{β} \\ ( 1 − ρϕ ) {W}_{i} ( n ) & , \text{} \frac{1}{β} \leq \vert {W}_{i} ( n ) \vert < \frac{1}{ϕ} \\ ( 1 - \frac{ρ}{ϕ} ) {W}_{i} ( n ) & , \text{} \frac{1}{ϕ} \leq \vert {W}_{i} ( n ) \vert\end{matrix} \qquad ( 8 )$$
wherein ρ is strength of attraction; β is boundary parameter that distinguishes between near-zero coefficient and small coefficient; ϕ is boundary parameter that distinguishes small coefficient and large coefficient, and effectively enlarges the small coefficient and reduces the large coefficient; within the range
$$\vert {W}_{í} ( n ) \vert < \frac{1}{β} ,$$
the function −Wᵢ(n) is substituted into function (5) to cancel out Wᵢ(n) in each iterative update formula, so that the iterative update formula containing product term μe(n)X(n) achieves a large zero-attraction penalty as the next coefficient of estimation filter; within the range
$$\frac{1}{β} \leq \vert {W}_{í} ( n ) \vert < \frac{1}{ϕ} ,$$
the function −ϕWᵢ(n) performs amplified zero attraction penalty for small coefficient, which is called floating coefficient; within the range
$$\frac{1}{ϕ} \leq \vert {W}_{í} ( n ) \vert ,$$
a new attraction method is adopted that a small amount of compensation is added when the coefficient value of the type is updated in each iteration, so that the coefficient of the estimation filter approaches the large coefficient value of the channel faster.

2. The sparse LMS method combining zero attraction penalty and attraction compensation according to claim 1, characterized in that: in the method, an estimation filter W(n) is set to make the coefficients of the estimation filter perform iterative update of equation (7) and subtract from the echo signal d(n) to obtain the final error signal e(n) to achieve echo cancellation.

3. The sparse LMS method combining zero attraction penalty and attraction compensation according to claim 1, characterized in that: the method is applied to the echo self-excitation problem existing in the same-frequency repeater, the acoustic echo phenomenon in the microphone and the noise cancelling earphone; in the repeater of wireless communication, the same-frequency repeater is arranged to expand the signal coverage by using adaptive filtering algorithm to solve the problem of self-excitation caused by echo;
the main transmitting platform emits useful signals and transmits them to the same-frequency repeater, and the same-frequency repeater amplifies the useful signals through the power amplifier and then transmits the useful signals to the receiving terminal;
the input signal X(n) of l_{c}-LMS is the signal transmitted by the transmitting platform, and H(n) represents the wireless sparse channel; the same-frequency repeater contains an estimation filter, and the same-frequency repeater will use the estimation filter to generate the received signal of the transmitting platform into y(n) signal; the same-frequency repeater synthesizes the received signal of the transmitting platform through the wireless sparse channel and the Gaussian white noise n(n) of the channel to generate a d(n) signal; inside the same-frequency repeater, e(n)=d(n)−y(n) is calculated to cancel the echo signal.
